(19) United States
(12) Patent Application Publication
(10) Pub. No.: US 2003/0112943 A1
(43) Pub. Date: Jun. 19, 2003

(54) Telephone call restrictor and related method of programming

(76) Inventor: Zvi Kamil, Tel - Aviv (IL)

Correspondence Address: OSTRAGER CHONG & FLAHERTY LLP, 825 THIRD AVE, 30TH FLOOR, NEW YORK, NY, 10022-7519, US

(21) Appl. No.: 10/025,646

(22) Filed: Dec. 19, 2001

(51) Int. Cl. H04M 1/66

(52) U.S. Cl. 379/200

(57) ABSTRACT

A programmable telephone call restriction device and a related method for remotely programming the call restriction device from an interactive voice response system or other computer. The call restriction device is connected in parallel at any point along a telephone connecting the telephone to be restricted and the local telephone exchange. If the user of the telephone dials a number that appears in a list of restricted numbers, the call restriction device will generate DTMF signals that prevent the telephone line from being used even if a connection is made to the dialed number. To program the call restriction device, the telephone user must first establish a telephone connection to the IVR system by dialing an access number. In response to a voice prompt from the IVR system, the telephone user must then input a valid authorization code, i.e., a valid personal identification number (PIN). Only after a valid PIN has been inputted will the IVR system issue voice prompts instructing the telephone user to input desired call restrictions, including telephone numbers to be restricted. The IVR system will then program the call restriction device in accordance with the inputted call restrictions. Thereafter, the call restriction device will restrict, limit or allow calls to destination stations in accordance with those call restrictions.

### FIELD OF THE INVENTION

This invention generally relates to a telephone call restriction device that is programmable by a computer. The invention also relates to a method for programming a telephone call restriction device.

### BACKGROUND OF THE INVENTION

In order to reduce telephone bills, telephone owners often desire to restrict telephone call access. For example, in a home, family or recreational setting, users want to either limit access by children, guests and sometimes even themselves. In the business arena, employers, in an effort to increase business productivity, have made telephones more accessible to their employees. However, employees sometimes spend more time on the telephone than necessary and make non-work related phone calls. Employers have a financial interest in minimizing the cost of personal phone calls made by employees, visitors, clients, customers, workmen, etc.

Costs associated with the unauthorized use of telephones have thus become a significant cost consideration for any telephone owner. Considerable time and expense has been devoted to addressing this problem. The most prevalent and promising approach has been to limit in some way the calls that can be made from one's telephone.

One way to decrease the cost of telephone service is to limit the telephone calls that can be made by controlling outbound access to the public telephone system, and in particular, to the local exchange. This can be accomplished by connecting a call restriction device to the telephone line of the telephone. Alternatively, a call restriction device can be incorporated inside the telephone. These call restriction devices operate on the principle that the costs associated with an unauthorized toll or other call can be prevented by blocking the call when the it is dialed.

Although telephone call restrictors are known in the art, they can be relatively expensive, difficult to program and information is not easily upgraded. One known outbound telephone call restrictor, disclosed in U.S. Pat. No. 4,975,943 to Weber et al., enables telephone calls when a series of outbound call digits belongs to a predetermined set of authorized series of digits. In addition, this call restriction device is built into the phone and restricts telephone calls to a local calling area by limiting telephone calls to those telephone numbers having a pre-selected maximum number of digits. A logic circuit powered by standard line current is connected between the standard telephone key encoder that receives and encodes the user-entered key dialing digits and a dialing signal converter that produces dialing pulses on the telephone line in response to the encoder.

U.S. Pat. No. 5,471,524 to Colvin discloses a telephone call restrictor that that is purportedly easier to program by the telephone user than prior art systems. The device is serially connected to the telephone line and requires that a user have, in order to program the call restrictor, direct communication with the call restrictor, and further requires entry of a code number to determine what mode the call restrictor is in (e.g., entry of “1” to allow any toll call to be placed and entry of “3” to allow the addition of new numbers to the telephone memory). A programmable processor is incorporated into the restrictor apparatus, allowing the user to override restrictions, enter new restrictions, or change the security code through entry of digits from a standard tone or pulse dialing telephone. Use of linear logic protocol in programming purportedly reduces complexity of programming and probability of error. The call restriction device is mounted to a wall plate. The device includes a printed circuit board comprising a microprocessor, a dual tone multiple frequency signal decoder and a memory.

U.S. Pat. No. 4,866,762 to Pintar discloses a programmable device for restricting outgoing telephone calls. The device comprises a microcontroller and a DTMF decoder. The device can be placed directly in the telephone lines, housed within a telephone set or installed in a wall jack. The microprocessor searches a list stored in RAM, interprets a command, and then either allows, prohibits or time limits the call. The call restrictor is spliced into the telephone line at a point between the telephone handset and the local exchange. The device is programmed by the user of the telephone set. The telephone user must first dial a toll-free number and then enter a four-digit authorization code. If the code is valid, the microcontroller generates a beep. The telephone user must then enter the call restriction data in the proper format. Each successful list entry is followed by a beep. The programming is terminated by a command selection.

There is a need for a telephone call restriction device that is easily programmable by a telephone owner desirous of restricting outgoing calls on his/her telephone.

### SUMMARY OF THE INVENTION

The present invention is directed to an apparatus for restricting outgoing telephone calls on a telephone line. The apparatus can be connected in parallel to the telephone line at any point between the telephone set's DTMF transmitter and the telephone switch located at the local exchange. For example, the call restriction device disclosed herein can be incorporated inside the telephone handset, attached to a wall mount, or connected to the telephone line that connects the handset to the wall mount. Alternatively, the call restriction device can be located at the local exchange.

The apparatus comprises a microcontroller that has nonvolatile memory for storing data (e.g., restricted telephone numbers, time restrictions and restriction mode) and programming. The apparatus further comprises a DTMF transceiver that converts DTMF dialing signals from the telephone being monitored into digital signals that are processed by the microcontroller. The call restriction device also communicates with a computer via the DTMF transceiver and the telephone line. In a line monitoring mode, the microcontroller compares digital signals representing a dialed number to restricted numbers stored in nonvolatile memory and, if the call is restricted, activates the DTMF transceiver to transmit a selected tone or tones (e.g., DTMF signals) that inhibits future operation until the telephone is placed on hook. In a programming mode, the microcontroller receives signals representing call restrictions, originating from a remote computer (e.g., an IVR system or a personal computer), and stores them in nonvolatile memory.

The present invention is further directed to a system and a method for restricting outgoing telephone calls on a telephone line. In accordance with one preferred embodiment, the system comprises a telephone, a local telephone exchange, a call restriction device placed on the line connecting the telephone to the local exchange, and an interactive voice response (IVR) unit that the telephone connects to via the local exchange. The invention is further directed to an IVR system that is programmed to send voice messages to the telephone user, receive call restrictions from the telephone user, and then program the call restriction device based on the call restrictions received from the telephone user.

To program the call restriction device, the telephone user must first establish a telephone connection to the IVR system by dialing an access number. In response to a voice prompt from the IVR system, the telephone user must input a valid authorization code, i.e., a valid personal identification number (PIN). Only after a valid PIN has been inputted will the IVR system issue voice prompts instructing the telephone user to input desired call restrictions, including telephone numbers to be restricted, associated time restrictions, allowed numbers, etc. The IVR system will then program the call restriction device in accordance with the inputted call restrictions. Thereafter, the call restriction device will restrict calls to the destination stations identified by the restricted telephone numbers. The call restriction device may also be programmed at the same time by inputting allowed telephone numbers or telephone numbers to which calls of limited duration are allowed. In this case, the allowed numbers have priority over restricted destination telephone numbers. The call restrictor also has an option to operate on the unlisted numbers (referred to herein as “the rest of the world”), and these may be time-limited, restricted (i.e., prohibited) or allowed.

In accordance with the preferred embodiment of the invention, the call restrictor has four categories of telephone numbers or area/country codes arranged under different tables in the memory of a microcontroller as follows: (1) restricted telephone numbers or area and/or country codes, etc. (the term “restricted” as used herein means blocking or prohibiting a call); (2) time-limited telephone numbers or area and/or country codes (the term “time-limited” as used herein means that a call is allowed, but will be limited in duration, e.g., after 2 minutes the call will be interrupted); (3) allowed telephone numbers (as used herein the term “allowed” refers to telephone numbers to which calls may be made without interruption; the term “allowed” usually refers to a full telephone number having an area code or country code that appears in either table 1 or table 2 as being either restricted or time-limited; in other words, an allowed telephone number for a restricted or time-limited area or country code is an exception to the rule that calls to that area or country code are not allowed or are time-limited); and (4) emergency and other telephone numbers that are never to be interrupted or prohibited, such as police, fire, or even 800 numbers. The telephone numbers, area codes and country that do not appear in any table make up the rest of the world of telephone numbers. The call restriction device in accordance with the preferred embodiment can be programmed to treat the “rest of the world” numbers as restricted, time-limited or allowed.

The invention is further directed to a method for programming a call restriction device, generally comprising the steps of: using a telephone (where the call restriction device is connected in parallel to it) to dial an access telephone number of an IVR system; establishing a connection between the telephone and the IVR system; sending a first voice message from the IVR system onto the telephone line requesting the telephone user to input an authorization code; inputting an authorization code at the telephone in response to the first voice message; receiving the authorization code at the IVR system; sending the authorization code from the IVR system to the call restriction device; validating the authorization code at the call restriction device; if the authorization code is valid, the call restriction device puts itself into the programming mode and sends a predetermined signal to the IVR system acknowledging it is ready to receive instructions; in response to the predetermined signal, the IVR system issues a voice message on the telephone line, requesting the caller to program the call restriction device; and the call restriction device is loaded by the IVR system with the numbers and/or codes inputted by the telephone user in response to voice prompts.

In accordance with an alternative preferred embodiment, the IVR system may be a speech-enabled IVR system, in which case the telephone user can use his own voice rather than DTMF inputs to input the authorization code and the call restrictions in response to voice prompting by the IVR system. In this case the speech-enabled IVR system is programmed with speech recognition software. The preferred software performs phonetic speech recognition, which breaks down spoken words into small fundamental sound units call phonemes.

In accordance with a further aspect of the preferred embodiment, the IVR system is programmed to remain silent in response to receipt of a predetermined message. In this case, a personal computer having a modem is connected to the telephone line of the telephone on which the call restrictor is connected. The personal computer is loaded with software for dialing up the access number of the IVR system; transmitting a first message onto the telephone line so that the IVR system will remain silent; transmitting a second message (including an authorization code) onto the telephone line for placing the call restriction device in a programmable mode; and then sending additional messages, based on operator input of desired call restrictions, that program the call restriction device. When programming of the call restriction device has been completed, the connection between the personal computer and the IVR system is terminated. Preferably, software for programming a call restriction device can be downloaded to the personal computer from a secure web server on the Internet. The use of a personal computer has the advantage that the call restrictions can be stored in memory and are thus readily recallable and modifiable by the PC user.

In accordance with a further alternative, a personal computer connected to the same telephone line can be used to program the call restriction device without accessing an IVR system. Any free line can be called in order to perform this procedure. Again the software for programming the call restriction device can be downloaded from a secure web server.

In accordance with another preferred embodiment of the invention, the IVR system is replaced by a personal computer having a modem. The personal computer is programmed with software for placing call restriction data in the format required by the call restriction device and for communicating with the call restriction device using a protocol recognized by the call restriction device.

Other features and advantages of the invention, including its preferred embodiments, will become apparent to those skilled in the art from the following detailed description and appended drawings.

### BRIEF DESCRIPTION OF THE DRAWINGS

FIG. 1 is a block diagram showing telephone call restriction system in accordance with a preferred embodiment of the invention.

FIGS. 2 and 3 are circuit diagrams showing respective portions of the circuitry of a telephone call restriction device in accordance with the preferred embodiment of the invention.

### DETAILED DESCRIPTION OF THE PREFERRED EMBODIMENTS

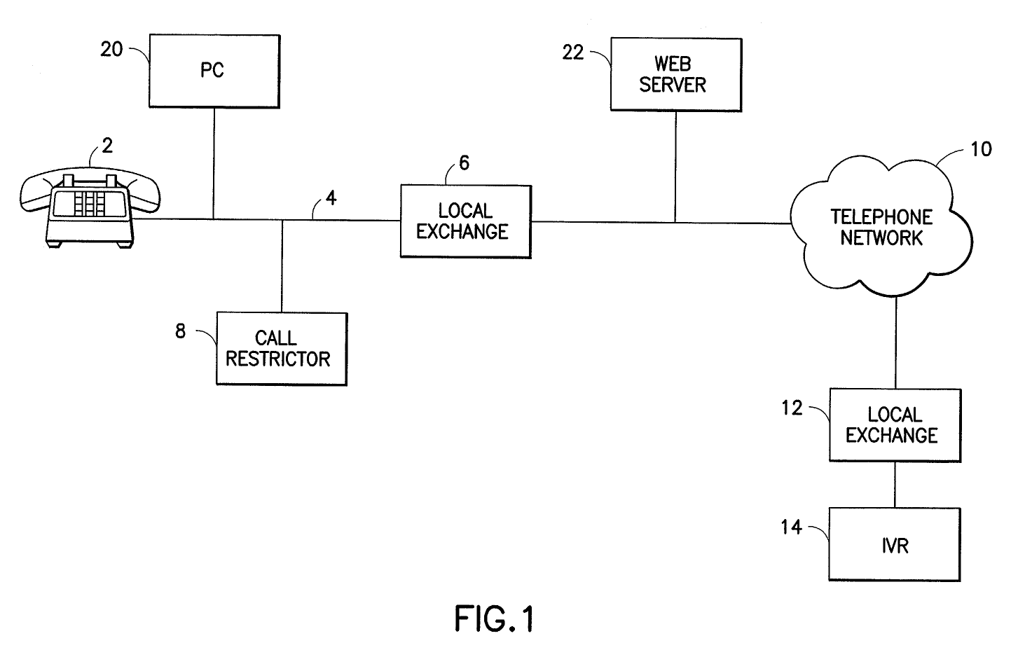

Referring to FIG. 1, a telephone call restriction system in accordance with a preferred embodiment of the invention comprises a telephone 2 connected via a telephone line 4 to a local telephone exchange 6. A remotely programmable telephone call restriction device 8 is connected in parallel to the telephone line 4 and is supplied with electrical power from the telephone line 4 only when the telephone 2 is off hook. The call restriction device 8 can be connected in parallel to the telephone line at any point between the telephone set's DTMF transmitter and the telephone switch located at the local exchange. Preferably, the call restriction device is incorporated inside the telephone, attached to a wall mount, or connected to the telephone line that connects the telephone to the wall mount. Alternatively, the call restriction device can be located at the local exchange or at any point between the aforementioned wall mount and the local exchange.

As is well known, the local telephone exchange 6 is connected to and forms part of the public telephone switching network 10. In accordance with the preferred embodiment of the invention, an interactive voice response (IVR) system 14 is connected to another local telephone exchange 12 that is similarly connected to the telephone network 10. The user of telephone 2 can be connected to the IVR system 14 by dialing the access telephone number of the IVR system 14. The call is routed via the local exchange 6, the telephone network 10 and the local exchange 12 in a well-known manner. The IVR system is programmed to send voice messages to the telephone 2, receive call restrictions from the telephone user, and then program the call restriction device 8 based on the call restrictions received from the telephone user.

To program the call restriction device 8, the user of telephone 2 must first establish a telephone connection to the IVR system 14 by dialing an access number. The connection between the telephone 2 and the IVR system 14 remains open throughout the programming procedure. In response to a voice prompt from the IVR system 14, the telephone user must input a valid authorization code, i.e., a valid personal identification number (PIN). Only after a valid PIN has been inputted will the IVR system 14 issue voice prompts instructing the telephone user to input desired call restrictions, including telephone numbers or area codes to be restricted and codes indicating the mode of call restriction to be applied to each restricted telephone number. For example, the telephone user may elect that a particular telephone number be totally blocked or merely time-limited (i.e., limits are placed on call duration). Alternatively, the telephone user may input a list of unrestricted telephone numbers to which calls are allowed and/or a list of time-limited telephone numbers to which calls limited in duration are allowed. Different lists may be provided corresponding to different time limits. Calls to any telephone number or to all telephone numbers in a particular group of telephone numbers (e.g., calls to a particular area code, calls to cell phones, international calls, and so forth) can be restricted. The IVR system 14 will then program the call restriction device 8 in accordance with the inputted call restrictions by placing the data in the format required by the call restriction device and sending that formatted data to the call restriction device in accordance with a communications protocol recognized by the call restriction device. Thereafter, the call restriction device 8 will restrict calls attempted on the telephone line in accordance with the programmed restrictions.

The call restriction device 8 is connected in parallel to the telephone line 4 and receives electrical power via the telephone line 4 only when the telephone 2 connected to the telephone line 4 is off hook. The call restriction device 8 consumes power only when the telephone is off hook and does not require a separate power supply, such as a battery or external power supply. Thus the call restriction device does not operate unless a positive seizure of the telephone line it is installed on occurs.

In accordance with the preferred embodiment, to program the call restriction device 8 (see FIG. 1), the user of telephone 2 must access the call restriction device via the IVR system 14. When the telephone user inputs his authorization code, i.e., PIN, that authorization code is received by the IVR system 14 and retransmitted by the IVR system 14 to the call restriction device 8 for validation. If the submitted authorization code is valid, the call restriction device then transmits a predetermined message to the IVR system to indicate that it is ready to be programmed, i.e., ready to receive call restriction data in the proper format. The IVR system 14 then prompts the telephone user to enter the call restrictions, including call restriction codes (i.e., allowed, restricted, time-limited, etc.), area codes, country codes, telephone numbers, and time limits. These inputs are received and processed by the IVR system 14. The IVR system 14 then transmits the call restrictions to the call restriction device 8 along with additional information. The call restriction device 8 then uses the transmitted information to program its nonvolatile memory. When the telephone user finishes this process, he/she sets the telephone on hook. The IVR system is disconnected and power is cut off to the call restriction device 8. The call restriction device 8 is then ready to monitor the telephone line and restrict outgoing telephone calls.

Still referring to FIG. 1, the call restriction device 8 operates only when the telephone 2 is off hook. In particular, the call restriction device comprises a circuit for supplying power to its processing and communications circuits only when a telephone off hook condition is detected on the telephone line 4. The call restriction device 8 further comprises a circuit for maintaining the interference on the telephone line 4 until a telephone on hook condition of sufficient duration is detected.

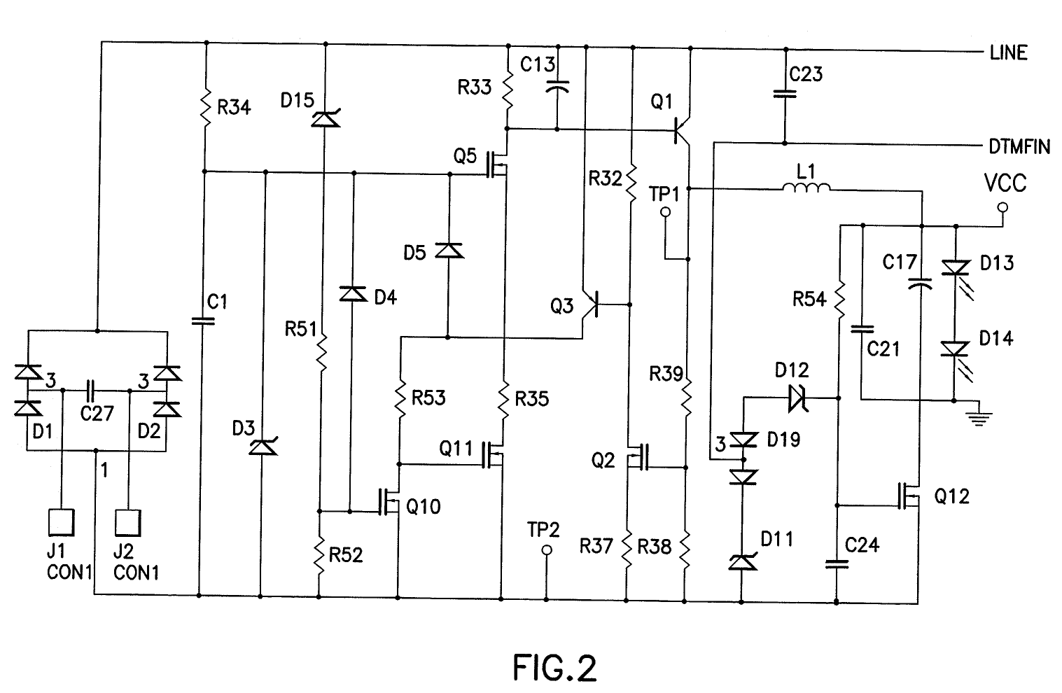

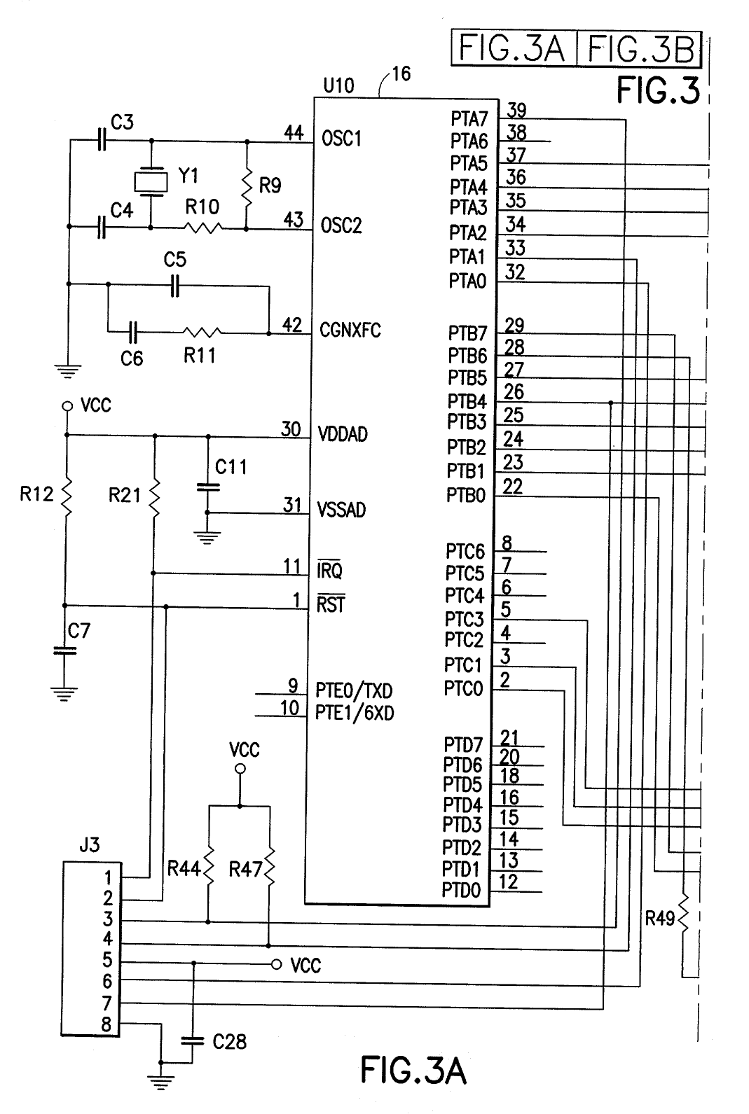

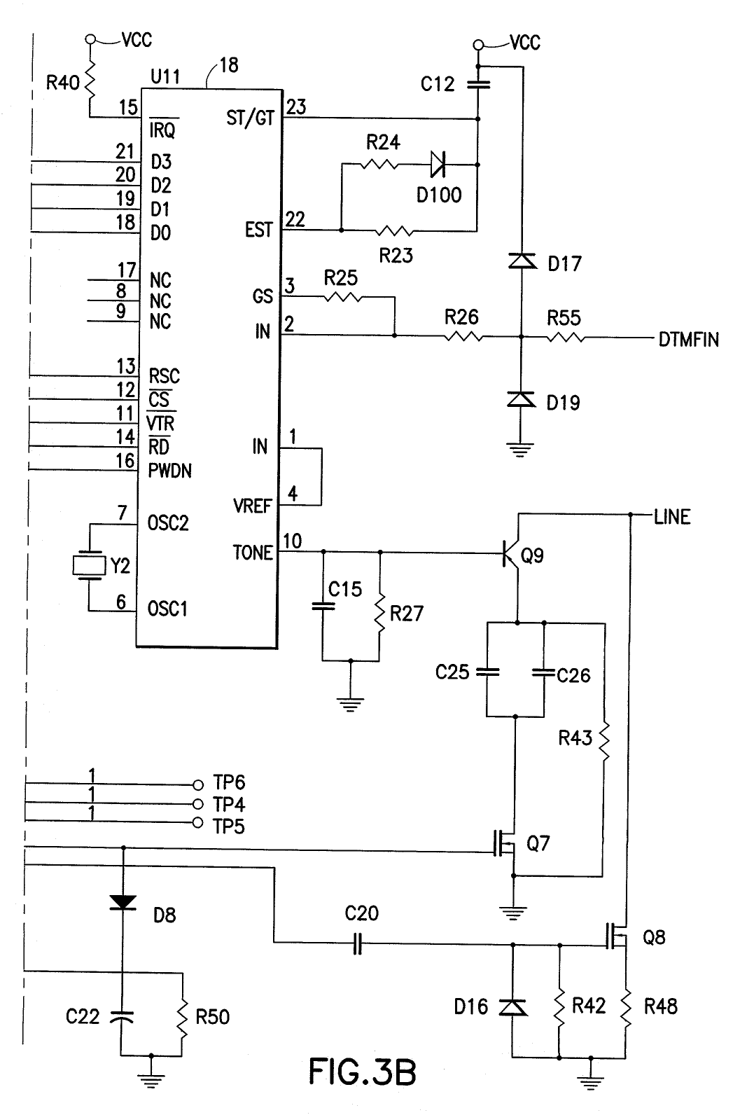

Referring to FIG. 2, the preferred embodiment comprises circuitry for detecting the drop in voltage due to the telephone being off hook. In particular, Zener diodes D3 and D15 detect this voltage drop on the telephone line (labeled LINE in FIG. 2) and output a stabilized voltage at the collector of transistor Q1 to feed the processing and communications components, i.e., the microcontroller and DTMF transceiver chips, described in more detail below. When the associated telephone is returned to an on hook condition, this circuit cuts out the voltage from the processing and communications components and loads the telephone line with negligible power, as allowed by the governing standards. The circuit comprising capacitors C23 and C24, and diodes D11, D12 and D19 detects the ringing signal when it arrives and, by use of FET Q12, inhibits the loading of the digital circuit by the ring signal when voltage is temporarily low. The communications signal on the telephone line is extracted by capacitor C23 and supplied to the line labeled DTMFIN in FIG. 2 (which is the input to the receiver portion of the DTMF receiver 18 in FIG. 3).

Referring to FIG. 3, the digital parts of the call restriction device 8 in accordance with the preferred embodiment of the invention comprises a microcontroller chip 16 and a DTMF transceiver chip 18. The microcontroller 16 has nonvolatile memory for storing call restriction data and one or more call restriction rule. The nonvolatile memory also stores the code that is executed by the microcontroller 16. The DTMF transceiver 18 has conductors for receiving tone signals from and sending tone signals to the telephone line and conductors for sending digital signals to and receiving digital signals from the microcontroller 16. The microcontroller 16 is programmed to detect that a call inhibition condition exists based on digital signals received from DTMF transceiver 18, the call restriction data and the call restriction rule or rules in effect. The microcontroller is further programmed to cause an interference on the telephone line in response to detection of a call inhibition condition.

More specifically, in a call restriction mode, the DTMF transceiver 18 converts all DTMF signals received on line DTMFIN (see FIG. 3) into digital signals, which digital signals are then passed to the microcontroller 16 for processing. The microcontroller 16 extracts the dialed telephone number from the digital signals, compares it to a list of telephone numbers stored in nonvolatile memory, and then takes appropriate actions in accordance with a stored call restriction procedure. If the microcontroller 16 detects that a telephone call to the dialed number should be blocked or interrupted, the microcontroller 16 activates the DTMF transceiver 18 to transmit a selected tone or tones (e.g., a DTMF signal) on the telephone line that will inhibit future operation until the telephone is placed on hook. The DTMF signals are output at terminal TONE on the transceiver chip 18 and coupled to the telephone line via transistor Q9 and the line labeled LINE in FIG. 3. The microcontroller 16 both instructs the DTMF transceiver 18 to transmit DTMF signals (e.g., a repeating sequence of numbers in DTMF format) and switches FET Q7 on, so that capacitors C25, C26 amplify the transmitted DTMF signals to an intensity sufficient to interfere with dialing or to interfere with an existing telephone call connection when necessary. The FET Q7 is inactive when the call restriction device is communicating with the IVR system or a computer modem.

In accordance with yet another aspect of the preferred embodiment depicted in FIG. 3, the call restriction device further comprises a circuit for resuming interference on the telephone line following a telephone off hook condition of insufficient duration. The circuit composed of capacitor C22, resistors R49 and R50, and diode D8 is a memory that remembers whether the telephone line was being interfered with prior to the occurrence of a telephone on hook condition. By using a short hook flash that takes the power off the call restriction circuits, the call restriction device is initialized, but if the on hook condition is too brief, the local telephone exchange will have not disconnected the line, so that the call restriction device can be bypassed. By this memory circuit, the call restriction device can continue to disturb the line unless the telephone was on hook long enough to ensure that the line was disconnected.

The microcontroller is programmed to change its mode of operation from a call restriction mode to a programming mode, in which the microcontroller is programmable, in response to receipt from the DTMF transceiver of digital signals representing a predetermined authorization code. In the call restriction mode, the microcontroller detects a call inhibition condition and causes an interference on the telephone line. In the programming mode, the microcontroller receives call restriction data via the DTMF transceiver and writes that call restriction data into the nonvolatile memory.

Still referring to FIG. 3, the call restriction device further comprises a circuit, comprising capacitor C20 and FET Q8, for disabling line disconnection during programming of the nonvolatile memory in the microcontroller.

In one implementation of the preferred embodiment of the invention, the resistances and capacitances depicted in FIGS. 2 and 3 have the following values:

Resistors: R9-4.7 Mega-ohms; R10-100 kilo-ohms; R11-10 kilo -ohms; R12-100 kilo-ohms; R23-390 kilo-ohms; R24-100 kilo-ohms; R25-100 kilo-ohms; R26-390 kilo-ohms; R27-10 kilo-ohms; R32-1 kilo-ohm; R33-10 kilo-ohms; R34-2 mega-ohms, R35-5.1 kilo-ohms, R37-1 kilo-ohms; R38-33 kilo-ohms; R39-33 kilo-ohms; R40-10 kilo-ohms; R42-1 mega-ohm; R43-330 ohms; R44-10 kilo-ohms; R47-10 kilo-ohms; R48-100 ohms; R49-100 kilo-ohms; R50-33 kilo-ohms; R51-1 mega-ohm; R53-2 mega-ohms; R54-100 kilo-ohms; R55-51 kilo-ohms.

Capacitors: C1-100 nano-farads; C3-20 pico-farads; C4-47 pico-farads; C5-10 nano-farads; C6-47 nano-farads; C7-100 nano-farads; C11-100 nano-farads; C12-100 nano-farads; C15-10 nano-farads; C16-47 micro-farads; C17-220 micro-farads; C20-1 micro-farad; C21-100 nano-farads; C22-47 micro-farads; C23-10 nano-farads; C24-1 micro-farad; C25-1 micro-farad; C26-1 micro-farad; C27-1 nano-farad; C28-100 nano-farads.

In accordance with another preferred embodiment of the invention, the IVR system 14 (see FIG. 1) can be replaced by a personal computer having a modem. The personal computer is programmed with software for placing call restriction data in the format required by the call restriction device and for communicating with the call restriction device using a protocol recognized by the call restriction device. The computer operator interacts with the telephone user to obtain the telephone user's authorization code and then sends signals representing the authorization code to the call restriction device. If the authorization code is valid, i.e., if the telephone user's authorization code matches the authorization code required by the call restriction device, then the call restriction device will respond with a message that it is ready to be programmed. The computer operator may then interact with the telephone user to obtain call restriction data. The call restriction data may include telephone numbers or area codes to which calls are prohibited, telephone numbers or area codes to which calls are limited in duration, telephone numbers or area codes to which calls are allowed, etc. The call restriction data is packaged in the format required by the call restriction device and sent from the personal computer to the call restriction device by the computer operator. The interaction between the computer operator and the telephone user can then cease and the call restriction device is ready for use.

In accordance with an alternative preferred embodiment depicted in FIG. 1, a personal computer 20 can be connected to the telephone line 4 via a modem. For example, a telephone owner having a telephone at his residence or business may connect a personal computer to the telephone line on which the telephone owner wants to restrict outgoing telephone calls. This personal computer 20 is programmed with software for communicating with both the IVR system 14 and the call restriction device 8 using the formats and protocols required by each. In particular, the personal computer 20 can be programmed to perform the following steps in response to appropriate inputs by the computer operator: dialing the access number of the IVR system 14; when a connection is established, sending a predetermined message that causes the IVR system to remain silent and not participate in the process of programming the call restriction device 8; while the connection is maintained, sending a valid authorization code that causes the call restriction device to issue a message indicating it is ready to be reprogrammed; and while the connection is maintained, sending call restriction data and/or procedures in a format required for the call restriction device to be reprogrammed. All call restriction data and/or call restriction procedures entered by the computer operator can be stored in system memory. This has the advantage of enabling the telephone user to review the call restrictions that are in effect on his/her telephone line at a particular time.

In accordance with a further alternative, the personal computer 20 connected to telephone line 4 can be used to program the call restriction device 8 without accessing an IVR system 14. Any free line can be called in order to perform this procedure, provided that arrangements are made at the destination station to maintain the telephone connection so that the personal computer will have a communication path to the call restriction device.

Software for programming the call restriction device can be downloaded by the operator of personal computer 20 from a secure web server 22 via the Internet in conventional manner. In accordance with a preferred embodiment, the web server 22 will not download the software unless the computer operator has entered a valid authorization code. A call restrictor vendor may provide a unique authorization code with each device sold. The person purchasing the call restrictor may then download the software to his/her personal computer to enable the call restrictor to be programmed.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments failing within the scope of the appended claims.

1. A telephone call restriction apparatus for connection to a telephone line, comprising:
a controller having memory for storing call restriction data and at least one call restriction rule; and
a transceiver having conductors for receiving tone signals from and sending tone signals to the telephone line and conductors for sending digital signals to and receiving digital signals from said controller,
wherein said controller is programmed to detect that a call inhibition condition exists based on digital signals received from said transceiver, said call restriction data and said call restriction rule, and to cause an interference on said telephone line in response to detection of a call inhibition condition.

2. The apparatus as recited in claim 1, wherein said transceiver sends a tone signal to the telephone line in response to said controller detecting that a call inhibition condition exists.

3. The apparatus as recited in claim 2, further comprising a circuit that increases the intensity of said tone signal on said the telephone line in response to said controller detecting that a call inhibition condition exists.

4. The apparatus as recited in claim 1, wherein said transceiver comprises a DTMF transceiver.

5. The apparatus as recited in claim 1, wherein said memory is nonvolatile.

6. The apparatus as recited in claim 1, further comprising a circuit for supplying power to said controller and to said transceiver only when a telephone off hook condition is detected on the telephone line.

7. The apparatus as recited in claim 1, further comprising a circuit for maintaining the interference on said telephone line until a telephone on hook condition of sufficient duration is detected.

8. The apparatus as recited in claim 1, further comprising a circuit for resuming the interference on said telephone line following a telephone off hook condition of insufficient duration.

9. The apparatus as recited in claim 1, wherein said controller comprises a microcontroller chip.

10. The apparatus as recited in claim 1, wherein said controller is further programmed to change its mode of operation from a call restriction mode to a programming mode in which said controller is programmable in response to receipt of digital signals representing a predetermined authorization code from said transceiver, said steps of detecting a call inhibition condition and causing an interference on said telephone line being performed in said call restriction mode.

11. The apparatus as recited in claim 10, wherein said controller is further programmed, when in said programming mode, to receive call restriction data from said transceiver and writing said call restriction data into said memory.

12. A method for programming a call restriction device connected to a telephone line, comprising the following steps:
establishing a connection between a telephone and a remote computer via the telephone line;
placing the call restriction device in a mode wherein the call restriction device is programmable;
sending signals representing call restriction data from the telephone onto the telephone line;
sending signals representing said call restriction data from the remote computer onto the telephone line; and
storing said call restriction data in the call restriction device so that the call restriction device, when in a call inhibition mode, will restrict calls on the telephone line in accordance with said stored call restriction data.

13. The method as recited in claim 12, further comprising the step of sending signals representing an authorization code from the telephone onto the telephone line prior to sending said signals representing call restriction data.

14. The method as recited in claim 12, further comprising the step of sending a voice prompt from the remote computer onto the telephone line, said voice prompt requesting input of call restriction data.

15. The method as recited in claim 13, further comprising the step of sending a voice prompt from the remote computer onto telephone line, said voice prompt requesting input of said authorization code.

16. A system comprising:
a telephone line;
a call restriction device connected to said telephone line and programmed to restrict calls on said telephone line in a call inhibition mode and to accept call restriction data in a programming mode;
a telephone connected to said telephone line; and
an interactive voice response system having an access number that is accessible via a public telephone switching network, wherein said interactive voice response system is programmed to perform the following steps:
sending a voice message requesting input of call restriction data while connected to said telephone line;
recognizing signals representing call restriction data returned via said telephone line following sending of said voice message requesting input of call restriction data; and
sending signals representing said call restriction data while connected to said telephone line.

17. The system as recited in claim 16, wherein said interactive voice response system is further programmed to perform the following steps:
sending a voice message requesting input of an authorization code while connected to said telephone line;
recognizing signals representing an authorization code returned via said telephone line following sending of said voice message requesting input of an authorization code; and
sending signals representing said authorization code while connected to said telephone line,
wherein said voice message requesting input of call restriction data is sent by said interactive voice response system only after detection of a predetermined signal indicating said authorization code is valid transmitted by said call restriction device.

18. The system as recited in claim 17, wherein said call restriction device is programmed to perform the following steps:
validating said authorization code sent by said interactive voice response system; and
changing modes from a call inhibition mode to a programming mode and sending said predetermined signal to said telephone line after validation of said authorization code.

19. A method for programming a call restriction device connected to a telephone line, comprising the following steps:
establishing a connection between a computer and a destination station via the telephone line;
placing the call restriction device in a mode wherein the call restriction device is programmable;
inputting call restriction data into the computer;
sending signals representing the inputted call restriction data from the computer onto the telephone line;
sending signals representing said call restriction data from the remote computer onto the telephone line; and
storing said call restriction data in the call restriction device so that the call restriction device will operate in said call inhibition mode in accordance with said stored call restriction data.

20. A telephone call restriction apparatus for connection to a telephone line, comprising:
memory for storing call restriction data in digital format;
a digital processor programmed to apply said call restriction rule to said call restriction data; and
a converter for converting tone signals on the telephone line into digital signals and converting digital signals from the digital processor into tone signals;
wherein said digital processor is further programmed to detect that a dialed telephone number belongs to a category of restricted telephone numbers and then restrict a call to a destination identified by said dialed telephone number in accordance with said call restriction data.

21. A telephone call restriction system comprising:
a telephone line;
a telephone connected to said telephone line;
a call restrictor connected to said telephone line; and
a computer communicative with said telephone and said call restrictor via said telephone line when a connection is established, said computer being programmed to automatically program said call restrictor based on call restrictions input via said telephone.

22. The system as recited in claim 21, wherein said computer is an interactive voice response system.

23. The system as recited in claim 21, wherein said call restrictor comprises:
a controller programmed to transmit first and second control signals in response to detection of a call inhibition condition;
a DTMF transceiver having a port for outputting DTMF signals in response to receipt of said first control signal from said controller; and
a circuit that increases the amplitude of the DTMF signals output from said port of said DTMF transceiver signals in response to receipt of said second control signal from said controller.

24. A method for preventing a telephone call to a restricted destination station, comprising the steps of:
monitoring a telephone line connected to a telephone;
detecting that a telephone number dialed on the telephone is restricted; and
generating a high-intensity DTMF signal on the telephone line in response to said detecting step, said high-intensity DTMF signal having sufficient intensity to interfere with a telephone call on the telephone line.

25. A telephone call restrictor programmed with call restrictions and having a programming mode and a call restriction mode, comprising:
a controller that is programmable in said programming mode and that detects call inhibition conditions as a function of said call restrictions in said call restriction mode;
a DTMF transceiver having a port for outputting DTMF signals in both said programming mode and said call inhibition mode; and
a circuit that increases the amplitude of the DTMF signals output from said port of said DTMF transceiver signals, said circuit being active when said controller has detected a call inhibition condition and being inactive at other times.
